(19) United States
(12) Patent Application Publication
(10) Pub. No.: US 2009/0204630 A1
(43) Pub. Date: Aug. 13, 2009

(54) DIGITAL VIDEO APPARATUS AND RELATED METHOD FOR GENERATING INDEX INFORMATION

(76) Inventors: Yung-Hsiao Lai, Taipei County (TW); Mei-Hua Wang, Miaoli County (TW); Yuan-Tao Wu, Santa Clara, CA (US); Chen Ma, San Jose, CA (US)

Correspondence Address: NORTH AMERICA INTELLECTUAL PROPERTY CORPORATION, P.O. BOX 506, MERRIFIELD, VA, 22116, US

(21) Appl. No.: 12/030,208

(22) Filed: Feb. 13, 2008

(51) Int. Cl. G06F 17/00

(52) U.S. Cl. 707/102; 707/E17.125

(57) ABSTRACT

A digital video apparatus includes a media receiver, a first storage device, and an index information generating module. The media receiver is used for receiving a media stream. The first storage device is coupled to the media receiver for storing the media stream received by the media receiver. The index information generating module is coupled to the media receiver for sequentially indexing the media stream to generate index information.

### BACKGROUND OF THE INVENTION

1. Field of the Invention

The present invention relates to a digital video apparatus and related method for generating index information, and more particularly, to a digital video apparatus and related method for generating index information indicative of a mapping relationship between recorded time and recorded position of a live media stream.

2. Description of the Prior Art

For live-media applications, such as digital TV broadcasting, saving live content into local storage and allowing users to view it later can bring great benefit compared with traditional TV viewing experiences. This is so-called time-shift or live pause features. However, some media data format, such as MPEG transport stream, lacks index information, which defines a mapping relationship between recorded time and recorded position of the media data within the local storage. As a result, when the users play the delayed content from the local storage, it's very difficult to implement time-accurate navigation operations. For example, if the users like to jump from the current playback position to exactly 30 seconds in the future, the conventional video playback apparatus can't decide where to read next when the index information is absent.

Furthermore, most live media sources provide multiple viewable media streams simultaneously, such as a plurality of DTV channels, so the users might toggle between different media streams from time to time while recording is in progress. However, for some media data format, it is not guaranteed that the concatenation of media data from different media streams can be played from start to end without significant interruptions. In a worst case, the video display quality is degraded greatly when several seconds of interruption is perceivable by the user.

### SUMMARY OF THE INVENTION

It is one of the objectives of the claimed invention to provide a digital video apparatus for generating index information and related method to solve the abovementioned problems.

According to an exemplary embodiment of the present invention, a digital video apparatus is provided for generating index information. The digital video apparatus includes a media receiver, a first storage device, and an index information generating module. The media receiver is used for receiving a media stream. The first storage device is coupled to the media receiver for storing the media stream received by the media receiver. The index information generating module is coupled to the media receiver for sequentially indexing the media stream to generate index information. The index information comprises a mapping relationship between recorded time and recorded position of the media stream stored in the first storage device. The digital video apparatus is a digital television (DTV), an analog TV with digital encoder, an internet protocol television (IPTV), a personal video recorder (PVR), or a digital set-top box.

According to another exemplary embodiment of the present invention, a method is provided for generating index information. The method includes receiving a media stream, storing the media stream, and sequentially indexing the media stream to generate index information. The index information comprises a mapping relationship between recorded time and recorded position of the media stream stored in the first storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a digital video apparatus for generating index information according to an embodiment of the present invention.

FIG. 2 is a diagram showing an example of the index information generating module shown in FIG. 1.

FIG. 3 is a diagram showing another example of the index information generating module shown in FIG. 1.

FIG. 4 is a diagram of a digital video apparatus for generating index information according to another embodiment of the present invention.

FIG. 5 is a diagram of an example of state information of a media stream according to an embodiment of the present invention.

FIG. 6 is a diagram of a digital video apparatus for generating index information according to yet another embodiment of the present invention.

FIG. 7 is a diagram illustrating how to compress the index information according to an embodiment of the present invention.

FIG. 8 is a diagram illustrating how to compress the index information according to another embodiment of the present invention.

FIG. 9 is a flowchart illustrating a method for generating index information according to an embodiment of the present invention.

FIG. 10 is a flowchart illustrating a method for generating index information according to another embodiment of the present invention.

### DETAILED DESCRIPTION

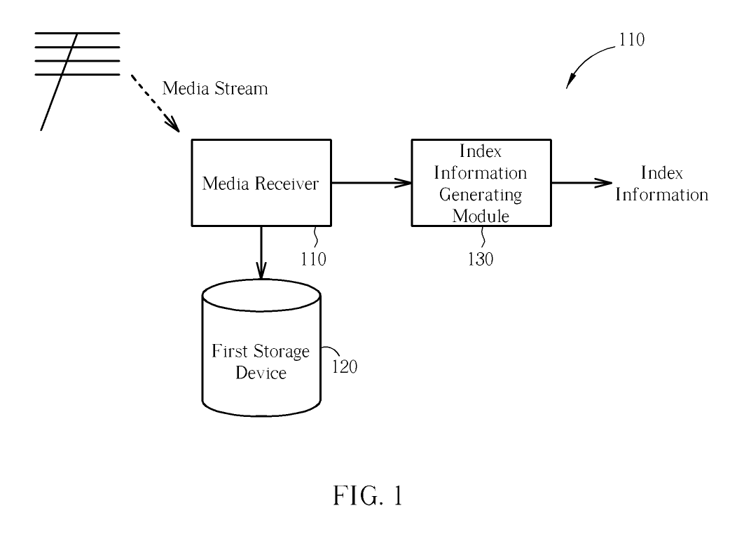

Please refer to FIG. 1. FIG. 1 is a diagram of a digital video apparatus 100 for generating index information according to an embodiment of the present invention. The digital video apparatus 100 includes, but is not limited to, a media receiver 110, a first storage device 120, and an index information generating module 130. The media receiver 110 is used for receiving a media stream, for example, a DTV broadcasting data. The first storage device 120 is coupled to the media receiver 110 for storing the media stream received by the media receiver 110. The index information generating module 130 is coupled to the media receiver 110 for sequentially indexing the media stream to generate index information. The index information includes a mapping relationship between recorded time and recorded position of the media stream stored in the first storage device 120.

Please note that, the abovementioned first storage device 120 can be a hard disc, but the scope of the present invention is not limited to this embodiment and the first storage device 120 can be implemented using storage devices of other types.

Please note that again, the above mentioned media stream includes data such as an audio-video stream transmitted from network or TV broadcasting signals, etc., but those skilled in the art should know that this is not a limitation of the present invention. That is, the digital video apparatus 100 of the present invention does not limit the source of the media stream. In addition, the digital video apparatus 100 comprises a digital television (DTV), an analog TV with digital encoder, an internet protocol television (IPTV), a personal video recorder (PVR), or a digital set-top box, but is not limited to this only and can be digital video apparatuses of other types.

In this embodiment, the index information includes a mapping relationship between recorded time and recorded position of the media stream stored in the first storage device 120, but this should not be a limitation of the present invention. As one skilled in the art will readily appreciate, the index information may further record other information.

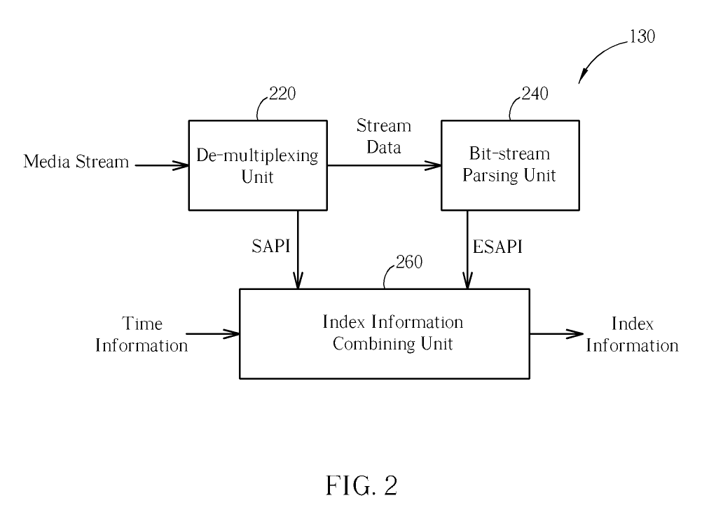

In the following, further descriptions for the architecture and operations of the index information generating module 130 are detailed as below. Please refer to FIG. 2. FIG. 2 is a diagram showing an example of the index information generating module 130 shown in FIG. 1. In this example, the index information generating module 130 includes, but is not limited to, a de-multiplexing unit 220, a bit-stream parsing unit 240, and an index information combining unit 260. The de-multiplexing unit 220 is used for receiving and dividing the media stream into a plurality of stream data and generating a plurality of stream access position information SAPI. The bit-stream parsing unit 240 is coupled to the de-multiplexing unit 220 for parsing the plurality of stream data to generate a plurality of elementary stream access position information ESAPI. The index information combining unit 260 is coupled to the de-multiplexing unit 220 and the bit-stream parsing unit 240, and is configured for combining the plurality of stream access position information SAPI, the plurality of elementary stream access position information ESAPI, and time information to generate the desired index information.

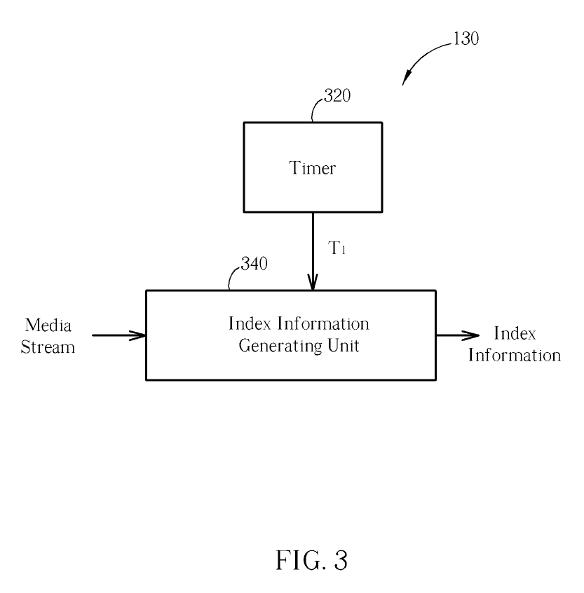

This approach above demands more computation power or dedicated hardware support since some manipulations are performed on considerably large amount of data during the processing stages of the de-multiplexing unit 220 and the bit-stream parsing unit 240. Therefore, a simple but effective approach is used to save burdens of de-multiplexing/parsing the media stream. Please refer to FIG. 3, which is a diagram showing another example of the index information generating module 130 shown in FIG. 1. As shown in FIG. 3, the index information generating module 130 includes a timer 320 and an index information generating unit 340. The timer 320 is used for counting a predetermined time span T₁ periodically (for example, every second). The index information generating unit 340 is coupled to the media receiver (as is shown in FIG. 1) and the timer 320. Assume that contents of the media stream are transmitted at a near constant speed, i.e., data for the certain amount of time worth of content should be transmitted within a near constant length time span. Therefore, the index information generating unit 340 records a position of the latest stored content of the media stream in the first storage 120 whenever the predetermined time span T₁ is expired to generate the index information.

The abovementioned embodiments are presented merely for describing features of the present invention, and in no way should be considered to be limitations of the scope of the present invention. Those skilled in the art should observe that various modifications and alterations of the index information generating module 130 and the digital video apparatus 100 may be made.

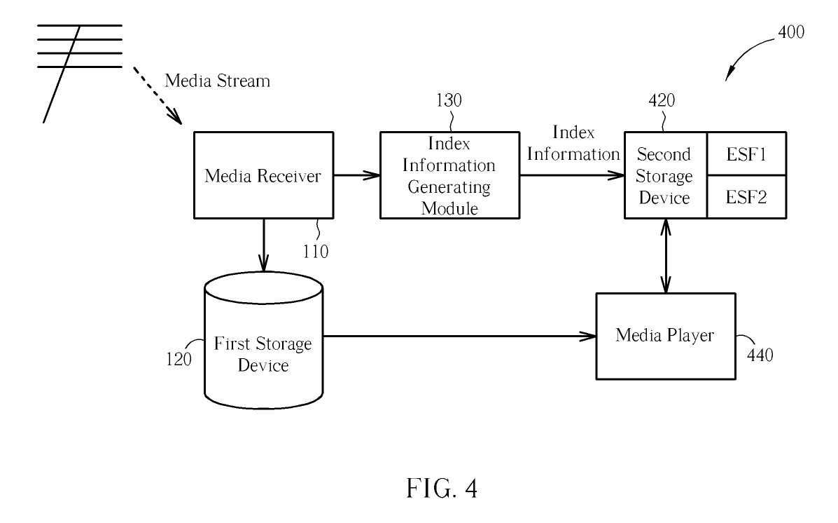

In order to provide much more functions to the record and playback of the digital video apparatus, the index information generated above should be stored in somewhere accessible. Please refer to FIG. 4. FIG. 4 is a diagram of a digital video apparatus 400 for generating index information according to another embodiment of the present invention. The digital video apparatus 400 is similar to the digital video apparatus 100 shown in FIG. 1. The difference between them is that the digital video apparatus 400 further includes a second storage 420 and a media player 440. As shown in FIG. 4, the second storage device 420 is coupled to the index information generating module 130 for storing the index information into a first entry storage field ESF1. The media player 440 is coupled to the first storage device 120 and the second storage device 420 for performing a playback function according to the media stream stored in the first storage device 120 and the index information stored in the first entry storage field ESF1 of the second storage device 420. Therefore, the media player 440 is not only capable of playing back the recorded media stream linearly, but also performing accurate time seeking (such as commercial skip, instant replay, or jump to a particular time, etc.) or scanning (such as fast forward or backward) through looking up the index information stored in the first entry storage field ESF1 of the second storage device 420.

Please note that, the abovementioned second storage device 420 can be a random access memory (RAM), but is not limited to this only and can be implemented using storage devices of other types.

In this embodiment, the playback function above can include, for example, play, pause, instant replay, rewind, seeking, fast forward, or commercial skip (CS), but this is not a limitation of the present invention. Furthermore, as operations of aforementioned playback functions are well known to those skilled in the art, further description is omitted here for brevity.

As abovementioned, most live media sources provide multiple viewable media streams simultaneously, such as a plurality of DTV channels or a mix of DTV channels and Analog TV channels coupled with digital encoder. Each viewable media stream may have completely different characteristics, for example, de-multiplexing parameters or encoding formats. Thus, when playing across the boundary of media streams of different characteristics, the digital video apparatus may completely stop functioning or take a lot of time to recover. This is to say, several seconds of interruption will occur. In order to prevent this situation from happening, to store state information of the media stream during recording of the media stream is necessary, wherein the state information includes de-multiplexing parameters or encoding formats, etc.

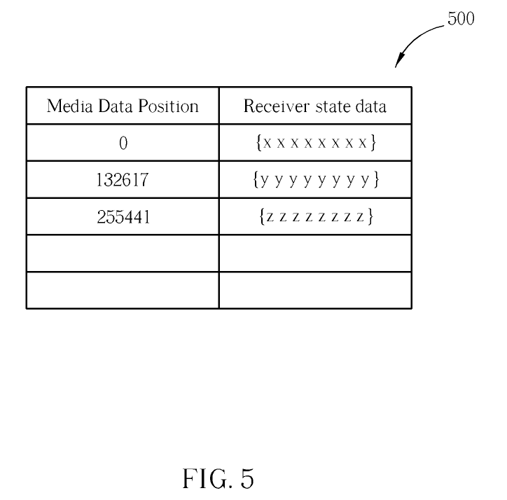

Please refer to FIG. 5 together with FIG. 4. FIG. 5 is a diagram of an example of state information 500 of the media stream according to an embodiment of the present invention. As shown in FIG. 4, the second storage device 420 further has a second entry storage field ESF2 for storing the state information 500 of the media stream. As shown in FIG. 5, the state information 500 of the media stream includes an entry for storing corresponding media data positions of the state information 500 and another entry for storing receiver state data of each viewable media stream (for example, each DTV channel), such as de-multiplexing parameters or encoding formats. The receiver state data is a variable number of bytes, whose internal format is user-defined. It can be used to carry important information regarding the current media stream, which starts from the corresponding media data position up to the media data position of the next media stream. The information carried by the receiver state data can then assist the playback end of the digital video apparatus 400 in quickly adjusting itself and dealing with the upcoming media stream of different characteristics. In other words, when users switch to a new media stream (for example, change viewing channel of DTV tuner), the recording end of the digital video apparatus 400 should generate and store the state information 500 into the second entry storage field ESF2 of the second storage device 420. Therefore, through the state information 500, including information exchange between the recording and playback ends of the digital video apparatus 400, the disclosed mechanism is able to provide these additional hints for the playback end to adjust itself quickly when it crosses territories of media streams of different characteristics.

Please note that, the abovementioned state information 500 is merely an embodiment for describing features of the present invention, and in no way should be considered to be limitations of the scope of the present invention. Those skilled in the art should observe that various modifications and alterations of the state information 500 may be made.

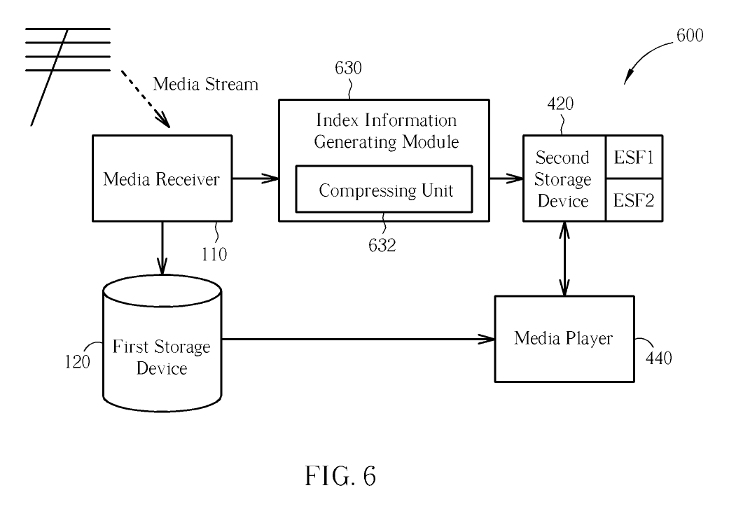

Please refer to FIG. 6. FIG. 6 is a diagram of a digital video apparatus 600 for generating index information according to yet another embodiment of the present invention. The digital video apparatus 600 is similar to the digital video apparatus 400 shown in FIG. 4. The difference between them is that an index information generating module 630 of the digital video apparatus 600 further includes a compressing unit 632. The compressing unit 632 compresses the index information through a specific compression manner. In the following embodiments, some examples are taken to describe how the compressing unit 632 compresses the index information.

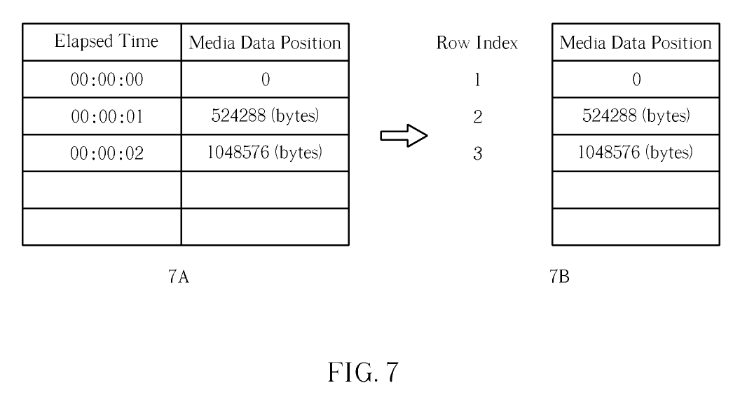

In a first example, the index information is compressed through reducing entry storage fields of the index information by the compressing unit 632. Please refer to FIG. 7, which is a diagram illustrating how to compress the index information according to an embodiment of the present invention. As shown in 7A, in general, the index information can be stored as simple as a two-column format, wherein one column is used for storing the elapsed time and the other column is used for storing the corresponding media data positions. However, if the representing time of each row can be found by counting the row index, the column for storing the elapsed time can be omitted. As shown in 7B, time internals between each row are all the same. Thus, only the column for storing the corresponding media data position is necessary while the column for storing the elapsed time can be omitted.

In a second example, the index information is compressed through lowering accuracy of the index information by the compressing unit 632. As shown in 7A and 7B, each row of the index information uses byte as a unit to store the media data position. Actually, the media data position doesn't need a resolution like this. It would be accurate enough to the users even if a unit as large as 64K bytes is adopted. If a larger unit is adopted, the number stored in the media data position field will be smaller. As a result, it takes fewer bits to store the media data position field.

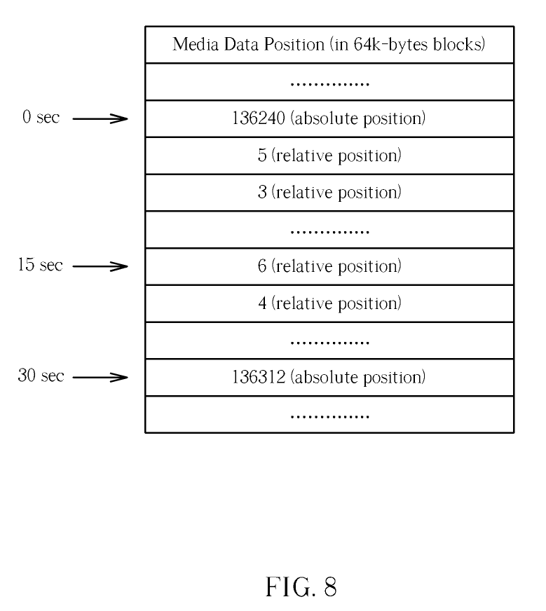

In a third example, the index information is compressed through replacing absolute positions with relative positions by the compressing unit 632. Please refer to FIG. 8, which is a diagram illustrating how to compress the index information according to another embodiment of the present invention. A trade off is made between accessing convenience and table size by establishing a number N, where the index information generating module keeps storing absolution position every N rows and uses relative position for the reminder (N−1) rows in between. For example, as shown in FIG. 8, assume that the first row is used for storing “0 second”, which stores an absolute position. The N^{th} row is used for storing “30 second”, which also stores an absolute position. The reminder rows between them are used for storing a time T confirming 0<T<30, which uses much fewer bits to store their relative positions because the relative position values are much smaller than the absolute position values. In other words, if the media player wants to find out the media data position of the “15 second”, the media player can first find out the absolute position of the “0 second” and then add on top of it the relative position values from row 2 to row 15 for the actual media data position of the “15 second”. In this way, the size of the index information can be reduced effectively.

Please note that, the abovementioned embodiments are presented merely for describing features of the present invention, and in no way should be considered to be limitations of the scope of the present invention. Those skilled in the art should observe that various modifications of the way the compressing unit 632 compresses the index information may be made.

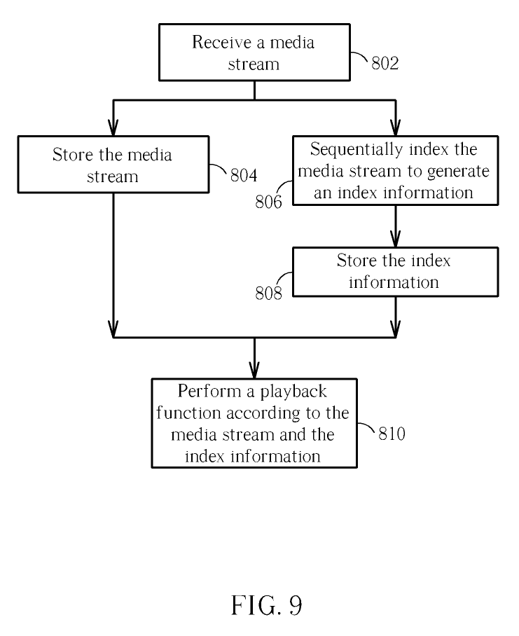

Please refer to FIG. 9. FIG. 9 is a flowchart illustrating a method for generating index information according to an embodiment of the present invention. Please note that the following steps are not limited to be performed according to the sequence shown in FIG. 9 if a roughly identical result can be obtained. The method includes the following steps:

Step 802: Receive a media stream.

Step 804: Store the media stream.

Step 806: Sequentially index the media stream to generate index information.

Step 808: Store the index information.

Step 810: Perform a playback function according to the media stream and the index information.

In the following description, how each element operates is described by collocating the steps shown in FIG. 9 and the elements shown in FIG. 4. In Step 802, the media receiver 110 first receives the media stream. The media stream is then stored in the first storage device 120 (Step 804). In Step 806-808, the media stream is sequentially indexed by the index information generating module 130 to generate the index information, and then the index information is stored into the first entry storage field ESF1 of the second storage device 420. Finally, the media player 440 performs a playback function according to the media stream stored in the first storage device 120 and the index information stored in the second storage device 420 (step 810).

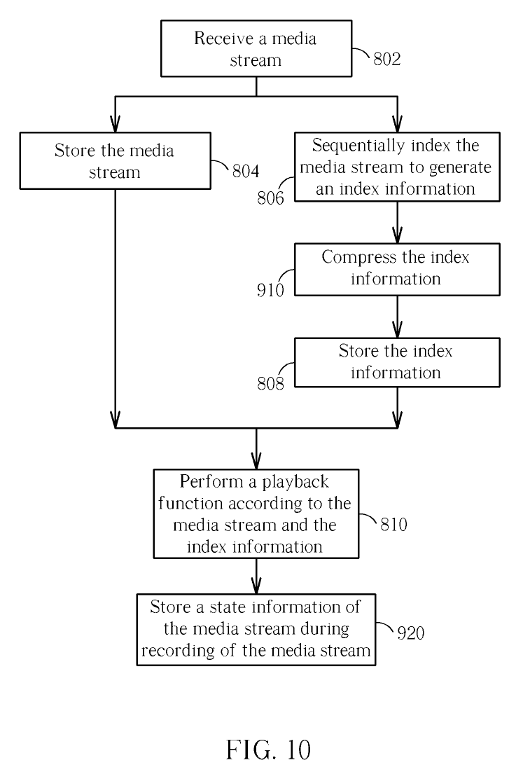

Of course, the abovementioned method is merely an exemplary embodiment of the present invention. In other embodiments, more functions are designated into the flow to provide the digital video apparatus 400 with more choices. Please refer to FIG. 10. FIG. 10 is a flowchart illustrating a method for generating index information according to another embodiment of the present invention. The exemplary method includes the following steps:

Step 802: Receive a media stream.

Step 804: Store the media stream.

Step 806: Sequentially index the media stream to generate index information.

Step 910: Compress the index information.

Step 808: Store the index information.

Step 810: Perform a playback function according to the media stream and the index information.

Step 920: Store state information of the media stream during recording of the media stream.

The steps shown in FIG. 10 are similar to that in FIG. 9. The difference between them is that FIG. 10 further adds a compressing function (i.e., Step 910) and a solution for multiple media streams of different characteristics (i.e., Step 920) into the method. In the following, how each element operates is described by collocating the steps shown in FIG. 10 and the elements shown in FIG. 6. In the steps 802-806, the operations are all the same as the steps 802-806 in FIG. 9, and further description is omitted here for brevity. In Step 910, the index information is first compressed by the compressing unit 632. And then the index information after being compressed is stored into the first entry storage field ESF1 of the second storage device 420 (Step 808). In Step 810, the media player 440 performs a playback function according to the media stream stored in the first storage device 120 and the index information stored in the second storage device 420. Besides, the state information of the media stream during recording of the media stream is stored into the second entry storage field ESF2 of the second storage device 420 (Step 920).

Provided that substantially the same result is achieved, the steps of the method shown in FIG. 9 and FIG. 10 need not be in the exact order shown and need not be contiguous, that is, other steps can be intermediate.

The abovementioned embodiments are presented merely for describing the present invention, and in no way should be considered to be limitations of the scope of the present invention. The abovementioned first storage device 120 can be a hard disc, but is not limited to this only and can be storage devices of other types. The abovementioned second storage device 420 can be a random access memory (RAM), but is not limited to this only and can be storage devices of other types. Please note that, the digital video apparatus of the present invention does not limit the source of the media stream. In addition, the digital video apparatus can include a digital television (DTV), an analog TV with digital encoder, an internet protocol television (IPTV), a personal video recorder (PVR), or a digital set-top box, but is not limited to this only and can be digital video apparatuses of other types. In the embodiments above, the index information includes a mapping relationship between recorded time and recorded position of the media stream stored in the first storage device 120, but this should not be a limitation of the present invention. As one skilled in the art will readily appreciate, the index information may further record other information. Furthermore, the playback function above can include, for example, play, pause, instant replay, rewind, seeking, fast forward, or commercial skip (CS), but this is not a limitation of the present invention. Of course, the abovementioned embodiments are presented merely for describing features of the present invention, and in no way should be considered to be limitations of the scope of the present invention. In other embodiments, more functions are designated into the digital video apparatus. For example, a compressing function or a solution for multiple media streams of different characteristics can be added into the digital video apparatus and the method of the present invention. Those skilled in the art should observe that various modifications of the compressing unit, the index information generating module, and the digital video apparatus may be made. Furthermore, the steps of the method shown in FIG. 9 and FIG. 10 need not be in the exact order shown and need not be contiguous, and can include other intermediate steps.

In summary, the present invention provides a digital video apparatus and related method for generating index information. Through generating and sharing the index information along with storing the media stream, the digital video apparatus of the present invention can implement time-accurate navigation operations when playing the delayed content from the local storage. Furthermore, through storing the state information of the media stream during recording of the media stream, the digital video apparatus is able to play across the boundary of media streams of different characteristics and different sources smoothly. Therefore, the digital video apparatus can prevent the situation of stopping functioning or interruptions from happening. In addition, through compressing the index information according to a specific compressing manner, the storage size for storing the index information can be reduced effectively and thereby manufacture cost of the digital video apparatus can be further lowered.

Those skilled in the art will readily observe that numerous modifications and alterations of the device and method may be made while retaining the teachings of the invention.

What is claimed is:

1. A digital video apparatus for generating index information comprising:
a media receiver used for receiving a media stream;
a first storage device, coupled to the media receiver, for storing the media stream received by the media receiver; and
an index information generating module, coupled to the media receiver, for sequentially indexing the media stream to generate index information.

2. The digital video apparatus of claim 1, wherein the index information comprises a mapping relationship between recorded time and recorded position of the media stream stored in the first storage device.

3. The digital video apparatus of claim 1, wherein the index information generating module comprises:
a bit-stream parsing unit, for generating a plurality of elementary stream access position information according to the media stream; and
an index information combining unit, coupled to the bit-stream parsing unit, for combining the plurality of elementary stream access position information and time information to generate the index information.

4. The digital video apparatus of claim 3, wherein the index information generating module further comprises:
a de-multiplexing unit, coupled to the bit-stream parsing unit and the index information combining unit, for dividing the media stream into a plurality of stream data and for generating a plurality of stream access position information, wherein the bit-stream parsing unit parses the plurality of stream data to generate the plurality of elementary stream access position information, and the index information combining unit combines the plurality of stream access position information, the plurality of elementary stream access position information, and time information to generate the index information.

5. The digital video apparatus of claim 1, wherein the index information generating module comprises:
a timer, for counting a predetermined time span periodically; and
an index information generating unit, coupled to the media receiver and the timer, for recording a position of the latest stored content of the media stream in the first storage whenever the predetermined time span is expired to generate the index information.

6. The digital video apparatus of claim 1, further comprising:
a second storage device, coupled to the index information generating module, for storing the index information; and
a media player, coupled to the first storage device and the second storage device, for performing a playback function according to the media stream stored in the first storage device and the index information stored in the second storage device.

7. The digital video apparatus of claim 6, wherein the playback function comprises play, pause, instant replay, rewind, seeking, fast forward, or commercial skip (CS).

8. The digital video apparatus of claim 1, wherein the index information comprises:
an entry storage field, for storing state information of the media stream during recording of the media stream, wherein the state information comprises de-multiplexing parameters or encoding formats.

9. The digital video apparatus of claim 1, wherein the index information generating module further comprises:
a compressing unit, for compressing the index information through reducing entry storage fields of the index information, lowering accuracy of the index information, or replacing absolute positions with relative positions.

10. The digital video apparatus of claim 1, wherein the digital video apparatus comprises a digital television (DTV), an analog TV with digital encoder, an internet protocol television (IPTV), a personal video recorder (PVR), or a digital set-top box.

11. A method for generating index information, applied to time-shift function, the method comprising:
receiving a media stream;
storing the media stream; and
sequentially indexing the media stream to generate index information.

12. The method of claim 11, wherein the index information comprises a mapping relationship between recorded time and recorded position of the media stream stored in the first storage device.

13. The method of claim 11, wherein the step of sequentially indexing the media stream to generate the index information comprises:
generating a plurality of elementary stream access position information according to the media stream; and
combining the plurality of elementary stream access position information and time information to generate the index information.

14. The method of claim 13, wherein the step of sequentially indexing the media stream to generate the index information further comprises:
dividing the media stream into a plurality of stream data and generating a plurality of stream access position information;
parsing the plurality of stream data to generate the plurality of elementary stream access position information; and
combining the plurality of stream access position information, the plurality of elementary stream access position information, and time information to generate the index information.

15. The method of claim 11, wherein the step of sequentially indexing the media stream to generate the index information comprises:
counting a predetermined time span periodically; and
recording a position of the latest stored content of the media stream whenever the predetermined time span is expired to generate the index information.

16. The method of claim 11, further comprising:
storing the index information; and
performing a playback function according to the media stream and the index information.

17. The method of claim 16, wherein the playback function comprises play, pause, instant replay, rewind, seeking, fast forward, or commercial skip (CS).

18. The method of claim 11, further comprising:
storing state information of the media stream during recording of the media stream, wherein the state information comprises de-multiplexing parameters or encoding formats.

19. The method of claim 11, further comprising:
compressing the index information through reducing entry storage fields of the index information, lowering accuracy of the index information, or replacing absolute positions with relative positions.
